(19) United States
(12) Patent Application Publication
(10) Pub. No.: US 2026/0222523 A1
(43) Pub. Date: Jul. 30, 2026

(54) DISPLAY SYSTEM AND INFORMATION PROCESSING DEVICE

(71) Applicant: SEIKO EPSON CORPORATION, Tokyo (JP)

(72) Inventors: Issei YOKOYAMA, Sapporo-shi (JP); Yuki MORI, Azumino-shi (JP); Hiroyuki ICHIEDA, Matsumoto-shi (JP); Yusaku MATOBA, Ueda-shi (JP); Thi anh tuyet NGUYEN, Shiojiri-shi (JP)

(73) Assignee: SEIKO EPSON CORPORATION, Tokyo (JP)

(21) Appl. No.: 19/458,307

(22) Filed: Jan. 23, 2026

(30) Foreign Application Priority Data
Jan. 24, 2025 (JP) 2025-010398

(51) Int. Cl. H04N 9/31

(52) U.S. Cl. CPC H04N 9/3185; H04N 9/3194

(57) ABSTRACT

According to an aspect of the present disclosure, there is provided a display system including a projection device configured to project an image and an information processing device including an imager and an inertial sensor. The projection device projects a first image including a first image pattern onto a projection surface and the information processing device acquires first captured image data obtained by capturing the first image with the imager and thereafter causes the projection device to project a second image obtained by performing geometric correction on the first image based on data of the first image, the first captured image data, and a detection value of the inertial sensor, receives an angle adjustment operation by a user, and causes, based on the angle adjustment operation, the projection device to project a third image obtained by rotating the second image about a normal vector of the projection surface.

The present application is based on, and claims priority from JP Application Serial Number 2025-010398, filed January 24, 2025, the disclosure of which is hereby incorporated by reference herein in its entirety.

### BACKGROUND

### 1. Technical Field

The present disclosure relates to a display system including a projection device and an information processing device and to an information processing device of the display system.

### 2. Related Art

For example, WO 2017/179111 discloses a display system including a video display device and a mobile terminal. According to this document, the video display device includes a projection unit that projects a plurality of measurement patterns and the mobile terminal includes a camera that images the plurality of measurement patterns projected by the projection unit and a controller that generates information concerning distortion correction for a video based on the plurality of measurement patterns imaged by the camera.

WO 2017/179111 is an example of the related art.

However, the display system of WO 2017/179111 has a problem in that a roll angle of a corrected projection image increases. Specifically, when distortion correction for a projection image is performed based on a captured image by the camera of the mobile terminal, since a relative positional relationship between the video display device and the camera is not determined in advance, the roll angle of the corrected projection image is larger compared with when the distortion correction for the projection image is performed based on a captured image by a camera of the video display device. The roll angle means that the base of the corrected projection image has a tilt with respect to a line segment parallel to the horizontal plane.

That is, a display system that can obtain a projection image with a small roll angle has been demanded.

### SUMMARY

According to an aspect of the present disclosure, there is provided a display system including: a projection device configured to project an image; and an information processing device including an imager and an inertial sensor, wherein the projection device projects a first image including a first image pattern onto a projection surface, and the information processing device acquires first captured image data obtained by capturing the first image with the imager and thereafter causes the projection device to project a second image obtained by performing geometric correction on the first image based on data of the first image, the first captured image data, and a detection value of the inertial sensor, receives an angle adjustment operation by a user, and causes, based on the angle adjustment operation, the projection device to project a third image obtained by rotating the second image about a normal vector of the projection surface.

According to an aspect of the present disclosure, there is provided an information processing device of a display system including: a projection device configured to project an image; and the information processing device including a communicator configured to communicate with the projection device, the information processing device further including an imager and an inertial sensor, the information processing device acquiring first captured image data obtained by capturing, with the imager, a first image including a first image pattern projected onto a projection surface by the projection device and thereafter causing the projection device to project a second image obtained by performing geometric correction on the first image based on data of the first image, the first captured image data, and a detection value of the inertial sensor, receiving an angle adjustment operation by a user, and causing, based on the angle adjustment operation, the projection device to project a third image obtained by rotating the second image about a normal vector of the projection surface.

### BRIEF DESCRIPTION OF THE DRAWINGS

FIG. 1 is a schematic configuration diagram of a display system according to a first embodiment.

FIG. 2 is a block diagram illustrating a schematic configuration of the display system.

FIG. 3 is a flowchart illustrating a flow of a first adjustment method.

FIG. 4 is a diagram illustrating an example of first image data.

FIG. 5 is a diagram illustrating a form of a projection image in an adjustment process.

FIG. 6 is a diagram illustrating an example of an adjustment screen.

FIG. 7 is a diagram illustrating a form of a projection image after adjustment.

FIG. 8 is a flowchart illustrating a flow of a second adjustment method according to a second embodiment.

FIG. 9 is a schematic configuration diagram of a display system.

FIG. 10 is a diagram illustrating an example of an operation screen.

FIG. 11 is a diagram illustrating an example of fourth image data.

FIG. 12 is a diagram illustrating an example of an adjustment screen according to a modification.

FIG. 13 is a diagram illustrating an example of an adjustment screen according to a modification.

### DESCRIPTION OF EMBODIMENTS

### First Embodiment

### Overview of a display system

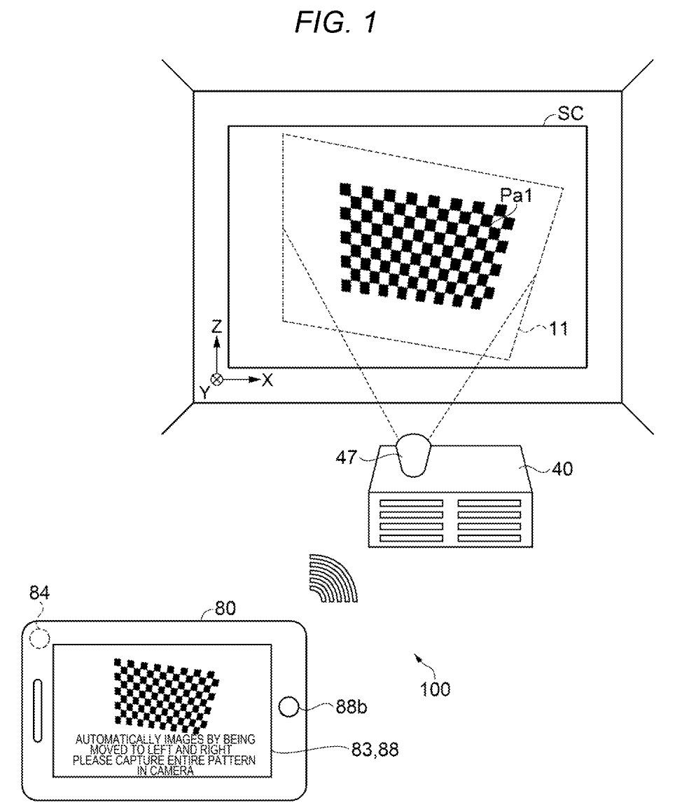

FIG. 1 is a schematic configuration diagram of a display system according to a first embodiment.

An embodiment of the present disclosure is explained below with reference to the drawings. The following embodiment is an embodiment for explaining an example of the present disclosure, and the present disclosure is not limited to the following embodiment and includes various modifications that can be implemented without changing the gist of the present disclosure. In the figures referred to below, dimensions and scales different from actual ones are sometimes used in order to facilitate understanding of the explanation.

As illustrated in FIG. 1, a display system 100 includes a projection device 40 and an information processing device 80.

The projection device 40 is, for example, a stationary projector and projects an image specified by image data. In FIG. 1, the projection device 40 projects a first image 11 onto, for example, a rectangular screen SC installed on a wall surface of a conference room. The wall surface is a substantially vertical surface and the screen SC attached along the wall surface is also substantially vertical. An X axis, a Y axis, and a Z axis, which are three axes orthogonal to one another, are illustrated in the figures including FIG. 1. In FIG. 1, a standing direction of the screen SC is represented as the Z axis and an extending direction of the Z axis is represented as a Z direction. The X axis is along a long side of the screen SC and an extending direction of the X axis is represented as an X direction. A direction orthogonal to the Z direction and the X direction is represented as a Y direction. In a preferred example, the X direction is along the horizontal direction and the Z direction is along the vertical direction. The screen SC is equivalent to a projection surface and the base of the screen SC is along the horizontal direction. The projection device 40 may be of a ceiling-suspended type installed on a ceiling. On the X axis, the distal end side of an arrow is also referred to as X plus direction and the opposite side of the X plus direction is also referred to as X minus direction. The same applies to the Y axis and the Z axis. The Z plus direction is also referred to as upward, and the Z minus direction is also referred to as downward.

The information processing device 80 is a smartphone and includes a display 83 and an imager 84. The display 83 is formed in a rectangular shape and includes a display device such as a liquid crystal display or an organic electro luminescence (EL) display. The display 83 includes a touch panel and functions as an operation unit 88 as well. An operation button 88b is provided beside the display 83. The operation button 88b is a part of the operation unit 88 and is a start button for starting the information processing device 80. The operation button 88b may have a fingerprint authentication function. The information processing device 80 is held sideways by a user such that a long side of the display 83 is along the X direction. The information processing device 80 is not limited to the smartphone and only has to be any portable information processing device having the same function and may be, for example, a laptop computer or a tablet computer.

In a preferred example, the projection device 40 and the information processing device 80 are capable of bidirectionally communicating with each other via a wireless local area network (LAN).

FIG. 1 illustrates an aspect at the time when an adjustment program for correcting distortion of a projection screen is executed. As explained in detail below, the adjustment program is a program for correcting the distortion of the projection screen such that the projection screen has a shape similar to the shape of the screen SC.

As illustrated in FIG. 1, the first image 11 is formed in a trapezoidal shape that is wide upward and narrow downward and is in a state in which the X plus side is tilted downward in the screen SC. In the first image 11, a first image pattern Pa1 having an outer shape similar to the outer shape of the first image 11 is displayed.

In FIG. 1, in the information processing device 80, the imager 84 captures the first image 11 according to the adjustment program and the captured image is displayed on the display 83. The entire first image pattern Pa1 fits in the captured image. Details of the adjustment program are explained below.

### Configuration of the projection device

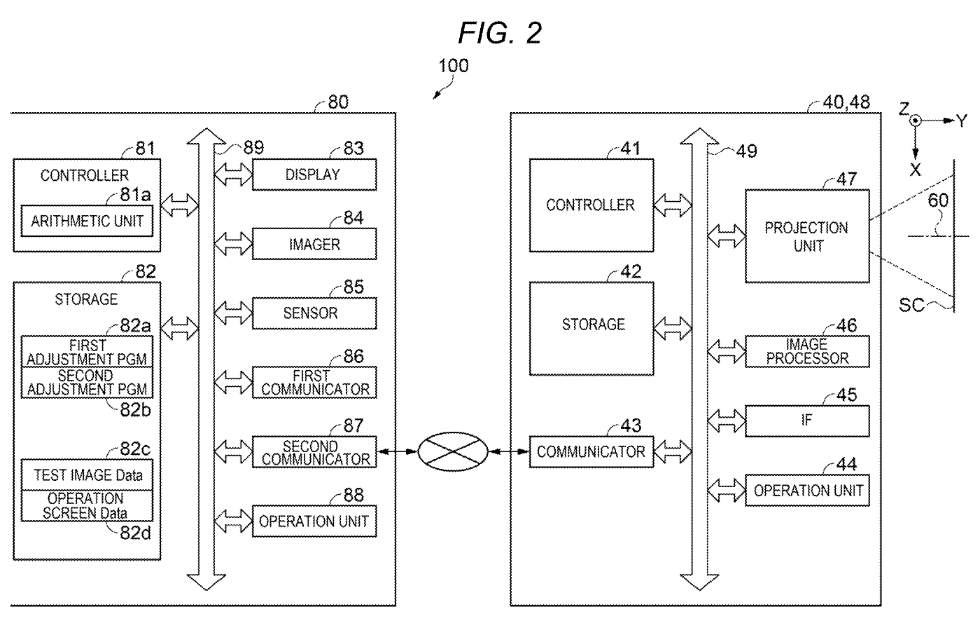

FIG. 2 is a block diagram illustrating a schematic configuration of the display system.

As illustrated in FIG. 2, the projection device 40 includes a controller 41, a storage 42, a communicator 43, an operation unit 44, an IF 45, an image processor 46, and a projection unit 47. The controller 41 is connected to the units described above via a system bus 49.

The controller 41 includes one or a plurality of processors and operates according to a control program stored in the storage 42 to thereby integrally control an operation of the projection device 40.

The storage 42 includes a random access memory (RAM) and a read only memory (ROM). The RAM is used to temporarily store various data and the like. The ROM stores a control program, control data, and the like for controlling the operation of the projection device 40. The control data includes coordinate data of four corners of a projection image.

The communicator 43 includes a wireless communication device for performing wireless communication through a wireless LAN, Bluetooth (registered trademark), or the like. The communicator 43 transmits and receives information to and from the information processing device 80 through wireless connection under the control of the controller 41.

The operation unit 44 includes a plurality of operation keys for the user to give various instructions to the projection device 40. As the operation keys provided in the operation unit 44, there are, for example, a "power key" for switching ON and OFF of a power supply, a "menu key" for displaying a menu for performing various kinds of setting, and a "direction key" for selecting an item of the menu. A remote controller (not illustrated) capable of performing remote control may be used as an input operation unit. In this case, the remote controller transmits an infrared operation signal corresponding to operation content of an operator and a not-illustrated remote controller signal receiver receives the operation signal and transmits the operation signal to the controller 41.

The IF 45 is an interface portion with an external device and includes a plurality of connection terminals including an HDMI (registered trademark, High-Definition Multimedia Interface) terminal. The plurality of connection terminals may further include, for example, a universal serial bus (USB) terminal, a video graphic array (VGA) terminal, and the like.

The image processor 46 applies necessary image processing to input image information based on the control of the controller 41 and outputs the processed image information to the projection unit 47. The image processing includes image processing for correcting distortion of a projection image according to correction parameters received from the information processing device 80.

The projection unit 47 includes a light source, a light modulation device, and a projection optical system (all of which are not illustrated). The projection unit 47 modulates light emitted from the light source with the light modulation device to form image light specified by image information and projects the image light from the projection optical system. As the light modulation device, for example, a liquid crystal panel or a digital micromirror device can be adopted. The light modulation device may be a single liquid crystal panel or digital mirror device or may include a plurality of liquid crystal panels or digital mirror devices. The projection optical system includes one or a plurality of optical elements that adjust magnification and an image forming position of the light output from the light modulation device.

The controller 41 and the image processor 46 may include one or a plurality of processors or may include a dedicated processing device such as an application specific integrated circuit (ASIC) or a field programmable gate array (FPGA).

### Configuration of the information processing device

As illustrated in FIG. 2, the information processing device 80 includes a controller 81, a storage 82, a display 83, an imager 84, a sensor 85, a first communicator 86, a second communicator 87, and an operation unit 88. The controller 81 is connected to the units described above via a system bus 89.

The controller 81 includes one or a plurality of processors. The controller 81 operates according to an operating system (OS) and a control program stored in the storage 82 to integrally control an operation of the information processing device 80.

The storage 82 includes memories such as a RAM and a ROM. The storage 82 stores an OS, a control program, various data, and the like. The control program includes a first adjustment program 82a and a second adjustment program 82b. The various data include test image data 82c and operation screen data 82d.

The display 83 includes a display device such as a liquid crystal display or an organic EL display and displays an image based on image information.

The imager 84 is a camera including an imaging element such as a charge coupled device (CCD) sensor or a complementary metal oxide semiconductor (CMOS) sensor. The imager 84 performs imaging based on the control of the controller 81. Captured image data is stored in the storage 82.

The operation unit 88 includes a touch panel integrally formed with the display 83 and an operation button 88b and receives input operation by the user. When the user operates the operation unit 88, the operation unit 88 outputs an operation signal corresponding to operation content to the controller 81 via the system bus 89.

The sensor 85 is an inertial sensor including a three-axis acceleration sensor and a three-axis gyro (angular velocity) sensor and detects the posture of the information processing device 80. The sensor 85 outputs a detection signal to the controller 81 via the system bus 89 according to a sampling frequency designated in advance.

The first communicator 86 is a communicator that executes data transmission and reception to and from a nearest not-illustrated base station via an antenna based on a fourth generation mobile communication system conforming to the IMT-Advance standard and/or a fifth generation mobile communication system conforming to the IMT-2020 standard.

The second communicator 87 includes a wireless communication device for performing wireless communication through a wireless LAN, Bluetooth (registered trademark), or the like. The second communicator 87 transmits and receives information to and from the projection device 40 through wireless connection based on the control of the controller 81.

In other words, the display system 100 includes the projection device 40 that projects an image and the information processing device 80 including the imager 84 and the sensor 85 including the inertial sensor. The information processing device 80 includes the second communicator 87 capable of communicating with the projection device 40.

### First adjustment method

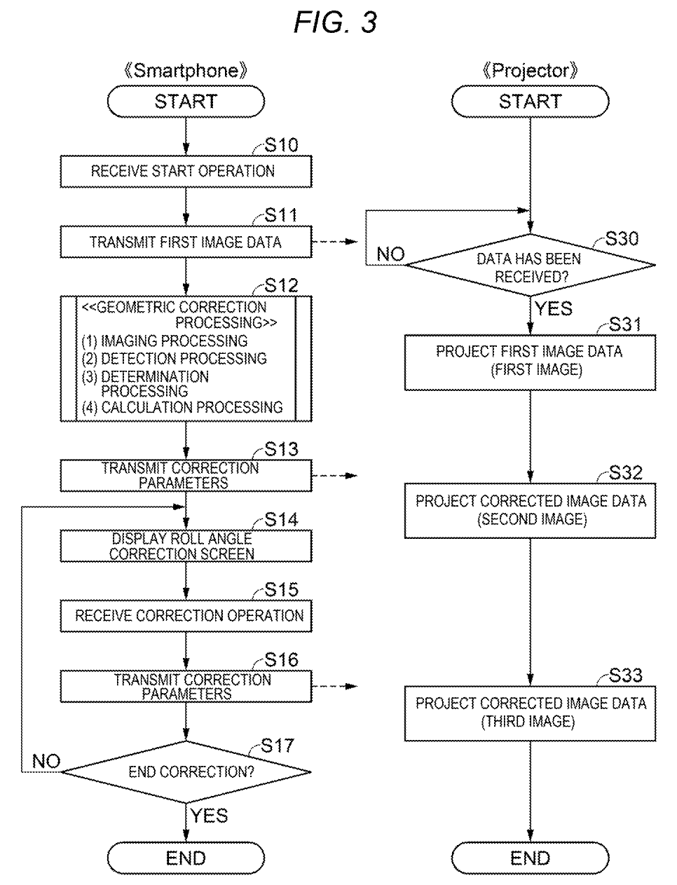

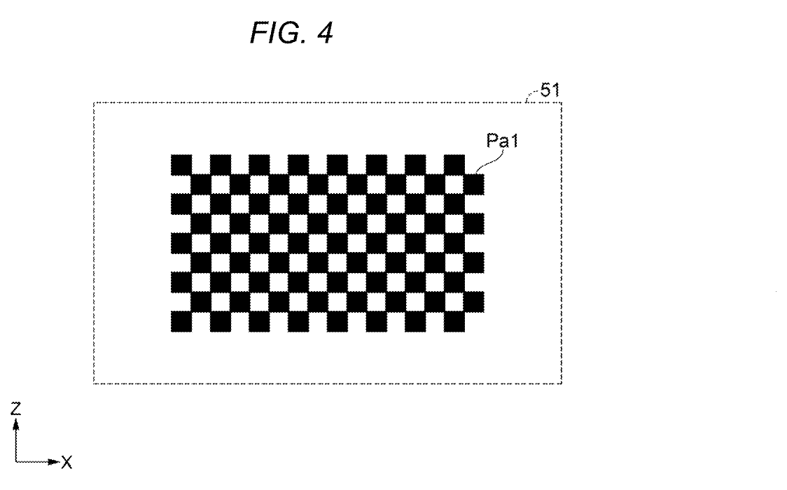

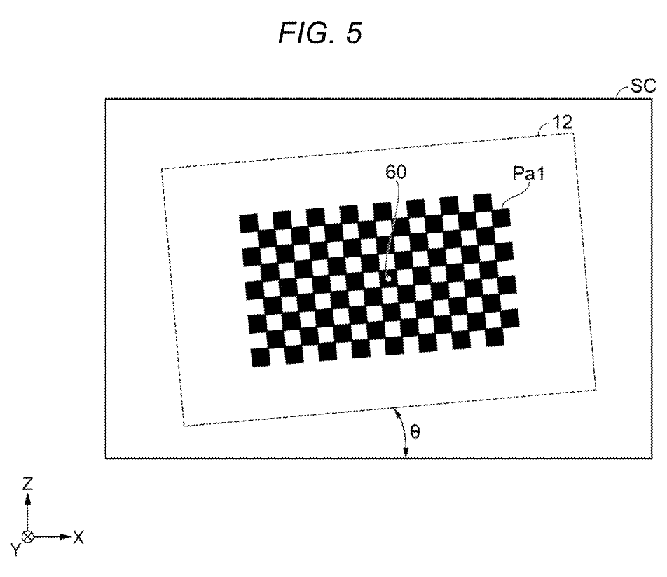

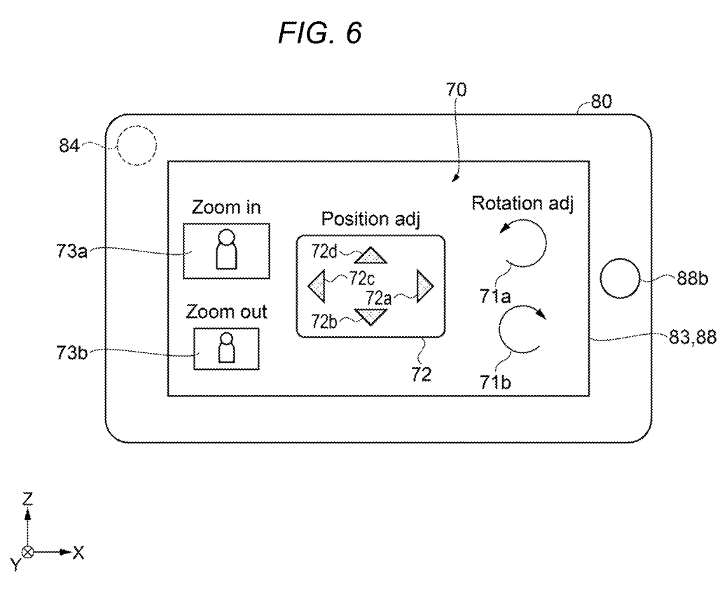

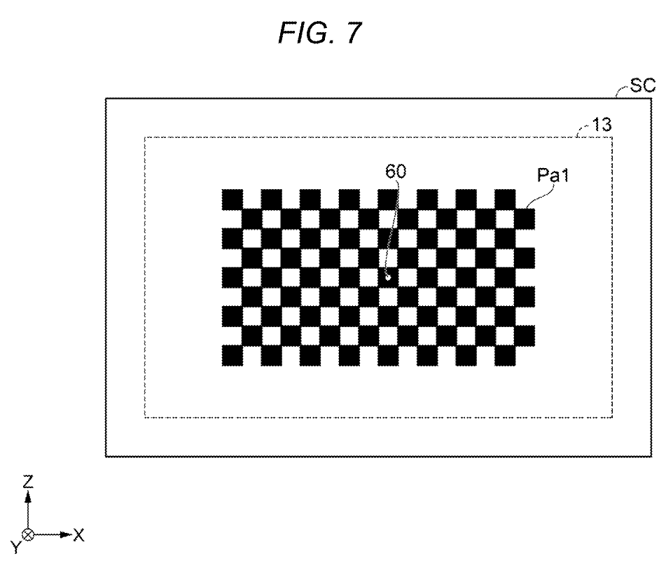

FIG. 3 is a flowchart illustrating a flow of a first adjustment method. FIG. 4 is a diagram illustrating an example of first image data. FIG. 5 is a diagram illustrating a form of a projection image in an adjustment process and corresponds to FIG. 1. FIG. 6 is a diagram illustrating an example of an adjustment screen. FIG. 7 is a diagram illustrating a form of an adjusted projection image and corresponds to FIG. 5.

Here, the first adjustment method for correcting distortion of a projection screen is explained mainly with reference to FIG. 3 and with reference to other drawings as appropriate.

The following steps are performed by the information processing device 80 executing the first adjustment program 82a. Specifically, the first adjustment program 82a is executed by the user operating an icon of a distortion adjustment program displayed on the display 83 of the information processing device 80. When the first adjustment program 82a is executed, the information processing device 80 and the projection device 40 are wirelessly connected. The projection device 40 operates according to a command of the information processing device 80. In the following explanation, execution subjects of steps are the controller 81 of the information processing device 80 and the controller 41 of the projection device 40.

In step S10, the information processing device 80 receives an adjustment start operation by the user. Specifically, when an adjustment start icon (not illustrated) on the display 83 is tapped, processing proceeds to step S11.

In step S11, the information processing device 80 reads the first image data from the test image data 82c in the storage 82 and transmits the first image data to the projection device 40. As illustrated in FIG. 4, first image data 51 is image data in which a first image pattern Pa1 formed of a chessboard pattern having a shape similar to a rectangular contour line indicated by a dotted line is arranged in the contour line. The first image pattern Pa1 is a checkered pattern in which black quadrangles and white quadrangles are alternately arranged in the X direction and the Z direction. Vertexes in a plurality of quadrangles are referred to as detection points or checker corners.

In step S30, the projection device 40 determines whether data has been received from the information processing device 80. When data has been received, the processing proceeds to step S31. When data has not been received, the projection device 40 continuously waits for data reception. Although the determination of the presence or absence of data reception from the information processing device 80 is also performed in the subsequent flow, the subsequent determination processing is not illustrated in FIG. 3.

In step S31, the projection device 40 projects an image specified by the received first image data 51. In FIG. 1, the first image 11, which is an example of a projection image, is illustrated. The first image 11 is formed in a trapezoidal shape that is wide upward and narrow downward and is in a state in which the X plus side is tilted downward in the screen SC. A first image pattern Pa1, which is a chessboard pattern, is displayed in the first image 11. In other words, the projection device 40 projects the first image 11 including the first image pattern Pa1 onto the screen SC serving as the projection surface.

In step S12, the information processing device 80 performs geometric correction processing. Specifically, kinds of processing of (1) to (4) explained below are performed.

In (1), the information processing device 80 causes the imager 84 to capture the first image 11. Specifically, as illustrated in FIG. 1, when the user presses the operation button 88b for starting imaging and then moves to the left and right in the X direction with respect to the screen SC in a state in which the user holds the information processing device 80, a plurality of captured images are captured at a plurality of imaging positions different from one another by the imager 84. At this time, a guide sentence "Automatic imaging is performed by moving right and left. Please capture the entire pattern with the camera." is displayed on the display 83.

In (2), the information processing device 80 analyzes each of the plurality of captured images to thereby detect the chessboard pattern from the captured images. Specifically, the information processing device 80 detects detection points of the chessboard pattern for each of the captured images.

In (3), the information processing device 80 determines whether the entire chessboard pattern has been detected from two or more captured images in (2) and, when the entire chessboard pattern has been detected from two or more captured images, proceeds to (4) processing. When the entire chessboard pattern has not been detected from two or more captured images, the information processing device 80 returns to the (1) processing.

In (4), the information processing device 80 calculates correction parameters. At this time, the controller 81 functions as an arithmetic unit 81a. First, the arithmetic unit 81a calculates a projective transformation matrix based on a detection point of the first image data 51 serving as a reference and a detection point of captured image data. The projective transformation matrix is a matrix for transforming a coordinate system in a captured image into a coordinate system in the projection device 40. In other words, the projective transformation matrix is a matrix for transforming a camera image coordinate system into a projector coordinate system.

Subsequently, the arithmetic unit 81a calculates a normal vector of the screen SC based on the projective transformation matrix and calculates a vertical vector of the screen SC based on the detection data of the sensor 85. Then, the arithmetic unit 81a calculates a horizontal vector of the screen SC based on the normal vector and the vertical vector of the screen SC and estimates a two-dimensional coordinate system of the screen SC.

Subsequently, the arithmetic unit 81a calculates a mutual transformation matrix of the projector coordinate system and the screen coordinate system. Specifically, the arithmetic unit 81a determines coordinates of four corners of a corrected projection screen such that the projection screen is rectangular on the screen SC and transforms the coordinates into coordinates in the projector coordinate system using the mutual transformation matrix. Then, the arithmetic unit 81a calculates correction parameters for distortion correction from the coordinates of the four corners in the projector coordinate system and the coordinates of the four corners of the projection screen.

In other words, the information processing device 80 acquires first captured image data of the first image 11 captured by the imager 84.

In step S13, the information processing device 80 transmits the calculated correction parameters to the projection device 40. In other words, the information processing device 80 causes the projection device 40 to project a second image 12 obtained by performing geometric correction on the first image 11 based on the first image data 51 serving as the reference, the first captured image data, and a detection value of the sensor 85.

In step S32, the projection device 40 generates second image data using the correction parameters received by the image processor 46 and projects an image specified by the second image data. In FIG. 5, the second image 12, which is an example of a projected second image, is illustrated. The second image 12 is a rectangular image but has a roll angle with respect to the screen SC. Specifically, the second image 12 has a roll angle of angle θ with respect to the base of the screen SC. For this reason, the second image 12 is an image tilted upward to the right with respect to the screen SC in the X direction. A size of the second image 12 with respect to the screen SC is rather small. In FIG. 5, the normal vector of the screen SC is set as a center line 60. As illustrated in FIG. 2, the center line 60 is a line segment extending in the Y direction from the center of the screen SC.

In step S14, an adjustment screen for the projection image is displayed on the display 83 of the information processing device 80. Specifically, the controller 81 reads adjustment screen data from the operation screen data 82d in the storage 82 and displays the adjustment screen on the display 83. As illustrated in FIG. 6, operation icons 71a and 71b for angle adjustment, an operation icon 72 for position adjustment, and operation icons 73a and 73b for scaling are displayed on the adjustment screen 70.

When the operation icon 71a for angle adjustment is tapped once, the projection image turns by 3° counterclockwise centering on the center line 60 (FIG. 5). Every time the operation icon 71a is tapped once, the projection image turns by 3° counterclockwise. Similarly, when the operation icon 71b is tapped once, the projection image turns by 3° clockwise centering on the center line 60. Every time the operation icon 71b is tapped once, the projection image turns by 3° clockwise. An angle of the turning is not limited to 3°.

In the operation icon 72 for position adjustment, triangular arrow icons 72a, 72b, 72c, and 72d are provided in a cross shape.

When the arrow icon 72a is tapped once, the projection image moves a predetermined distance in the X plus direction. Similarly, when the arrow icon 72c is tapped once, the projection image moves a predetermined distance in the X minus direction. When the arrow icon 72b is tapped once, the projection image moves a predetermined distance in the Z minus direction. Similarly, when the arrow icon 72d is tapped once, the projection image moves a predetermined distance in the Z plus direction. By operating the arrow icons 72a, 72b, 72c, and 72d, the projection image can be moved upward and downward and to the left and the right.

When the operation icon 73a for enlargement is tapped once, the projection image becomes one size larger. Similarly, when the operation icon 73b for reduction is tapped once, the projection image becomes one size smaller. The size of the projection image can be changed by operating the operation icons 73a and 73b.

In step S15, the information processing device 80 receives an operation on the adjustment screen 70. For example, when the user operates the operation icon 71b for angle adjustment and the operation icon 73a for enlargement on the second image 12 illustrated in FIG. 5, correction parameters corresponding to the operation are generated.

In step S16, the information processing device 80 transmits the correction parameters corresponding to the operation content to the projection device 40. In other words, the information processing device 80 receives an angle adjustment operation by the user and causes, based on the angle adjustment operation, the projection device 40 to project a third image 13 obtained by rotating the second image 12 about the center line 60, which is the normal vector of the projection surface.

In step S33, the projection device 40 generates third image data using the correction parameters received by the image processor 46 and projects an image specified by the third image data. In FIG. 7, the third image 13, which is an example of a projected third image, is illustrated. The projection device 40 stores parameters including coordinates of four corners of the third image data in the storage 42.

The third image 13 is formed in a rectangular shape, the bottom of which extends along the bottom of the screen SC, and has a size appropriate for the screen SC.

In step S17, an operation screen (not illustrated) for confirming whether to end the adjustment by the adjustment screen 70 is displayed on the display 83 of the information processing device 80. When an end icon has been operated, the information processing device 80 ends the processing. When a continuation icon has been operated, the information processing device 80 returns to step S14 and continues the adjustment by the adjustment screen 70. When a predetermined time has elapsed after the operation screen has been displayed, the information processing device 80 may regard that the correction processing has ended and end the processing.

As explained above, with the display system 100 and the information processing device 80 in the present embodiment, the following effects can be obtained.

The display system 100 includes the projection device 40 that projects an image and the information processing device 80 including the imager 84 and the sensor 85 including the inertial sensor, the projection device 40 projects the first image 11 including the first image pattern Pa1 onto the screen SC serving as the projection surface, and the information processing device 80 acquires the first captured image data obtained by capturing the first image 11 with the imager 84 and thereafter causes the projection device 40 to project the second image 12 obtained by performing the geometric correction on the first image 11 based on the first image data 51 serving as the reference, the first captured image data, and a detection value of the sensor 85, receives the angle adjustment operation by the user, and causes, based on the angle adjustment operation, the projection device 40 to project the third image 13 obtained by rotating the second image 12 about the center line 60, which is the normal vector of the projection surface.

Accordingly, since the geometric correction is performed on the first image 11 based on the first image data 51 serving as the reference, the first captured image data, and the detection value of the sensor 85 and the second image 12 subjected to the geometric correction is rotated about the center line 60, which is the normal vector of the screen SC serving as the projection surface, it is possible to reduce a roll angle of the corrected third image 13 with respect to the screen SC.

Therefore, it is possible to provide the display system 100 that can obtain a projection image having a small roll angle.

The information processing device 80 transmits the data of the first image to the projection device 40. Specifically, the information processing device 80 reads the first image data from the test image data 82c in the storage 82 and transmits the first image data to the projection device 40. That is, the first image data including the first image pattern Pa1 is stored in the information processing device 80.

Thus, when the first adjustment program 82a including the first image data is updated, it is unnecessary to update both of a program stored in the projection device 40 and a program stored in the information processing device 80 and only the first adjustment program 82a has to be updated. Thus, it is possible to reduce a work load on the user. The same applies to the second adjustment program 82b.

The information processing device 80 is an information processing device of a display system including the projection device 40 that projects an image and the information processing device 80 including the second communicator 87 capable of communicating with the projection device 40, the information processing device 80 further includes the imager 84 and the sensor 85 including the inertial sensor, acquires first captured image data obtained by capturing, with the imager 84, the first image 11 including the first image pattern Pa1 projected onto the screen SC by the projection device 40 and thereafter causes the projection device 40 to project the second image 12 obtained by performing geometric correction on the first image 11 based on the first image data 51 serving as the reference, the first captured image data, and a detection value of the sensor 85, receives an angle adjustment operation by the user, and causes, based on the angle adjustment operation, the projection device 40 to project the third image 13 obtained by rotating the second image 12 about the center line 60, which is the normal vector of the projection surface.

Accordingly, it is possible to provide the information processing device 80 suitable for the display system 100 that can obtain a projection image having a small roll angle.

### Second Embodiment

### Different aspects of an adjustment method

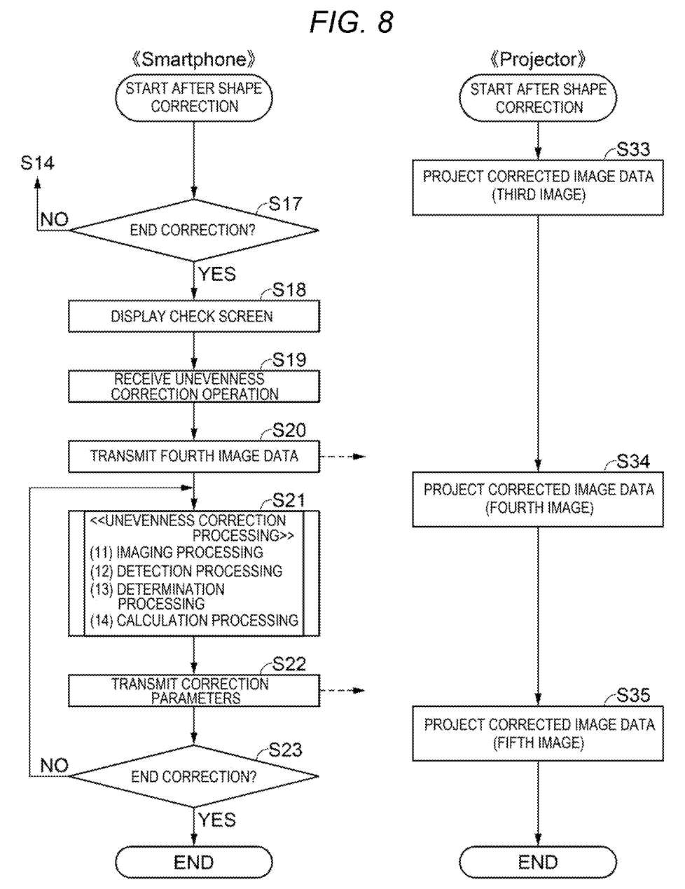

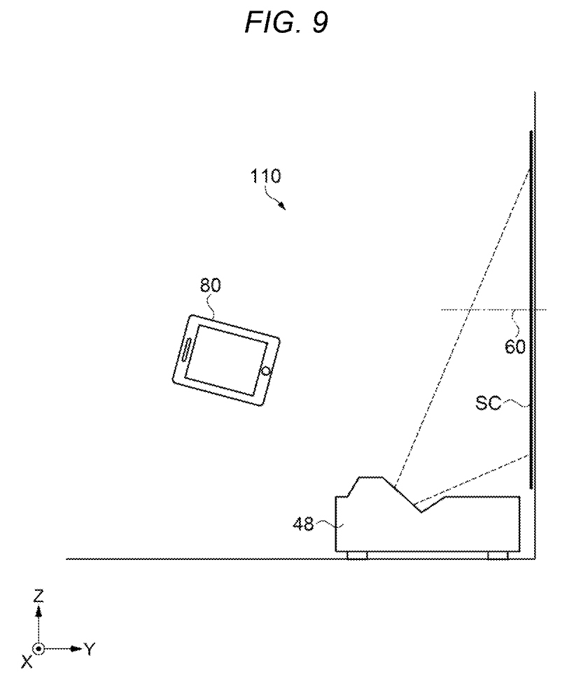

FIG. 8 is a flowchart illustrating a flow of a second adjustment method according to a second embodiment and corresponds to FIG. 3. FIG. 9 is a schematic configuration diagram of a display system and corresponds to FIG. 1.

In the embodiment explained above, the shape of the projection image is corrected by performing the geometric correction for correcting distortion and the roll angle correction. However, the correction is not limited thereto and unevenness of a projection image may be further corrected.

In the following explanation, the same parts as the parts in the embodiment explained above are denoted by the same reference numerals and signs and a redundant explanation of the parts is omitted.

As illustrated in FIG. 9, the display system 110 in the present embodiment includes a projection device 48 and the information processing device 80. The projection device 48 of the present embodiment is a short-focus projector and is installed substantially directly below the screen SC installed along a wall surface. A configuration of the projection device 48 is basically the same as the configuration of the projection device 40 illustrated in FIG. 2. However, the projection unit 47 includes an optical system corresponding to short-focus projection including a wide-angle lens. The information processing device 80 is the same as the information processing device 80 illustrated in FIG. 2. However, in the present embodiment, the information processing device 80 executes the second adjustment program 82b in the storage 82. Otherwise, the explanation is the same as the explanation in the first embodiment.

As illustrated in FIG. 9, in the short-focus projection device 48, a projection angle (an elevation angle) of an image is larger compared with the stationary projection device 40 illustrated in FIG. 1. When the projection angle increases, slight unevenness (undulation) of a screen, which does not cause a problem in a normal projector, affects a projection image and distortion occurs. With a second adjustment method in the present embodiment, unevenness correction can be performed in addition to the shape correction by the geometric correction and the roll angle correction. The projection device 48 may be installed above the screen SC. In this case, installation equipment protruding in the Y minus direction from the wall surface is provided above the screen SC. The projection device 48 is fixed to the installation equipment and projects an image from obliquely above the screen SC.

Steps explained below are performed by the information processing device 80 executing the second adjustment program 82b. Specifically, the second adjustment program 82b is executed by the user operating an icon (not illustrated) of the distortion adjustment program displayed on the display 83 of the information processing device 80. Since the second adjustment program 82b is a flow of performing unevenness correction following the first adjustment program 82a, in the following explanation, step S17 and subsequent steps are explained for the information processing device 80 and step S33 and subsequent steps are explained for the projection device 48. Contents before the steps are the same as the contents explained with reference to FIG. 3.

### Second adjustment method

Step S17 in FIG. 8 is the same as step S17 in FIG. 3. Specifically, in step S17, an operation screen (not illustrated) for confirming whether to end adjustment by the adjustment screen 70 (FIG. 6) is displayed on the display 83 of the information processing device 80. When a continuation icon has been operated, the information processing device 80 returns to step S14 and continues the adjustment by the adjustment screen 70.

Here, it is assumed that the end icon has been operated. At this time, the projection device 48 projects the third image 13 (FIG. 7) by the third image data.

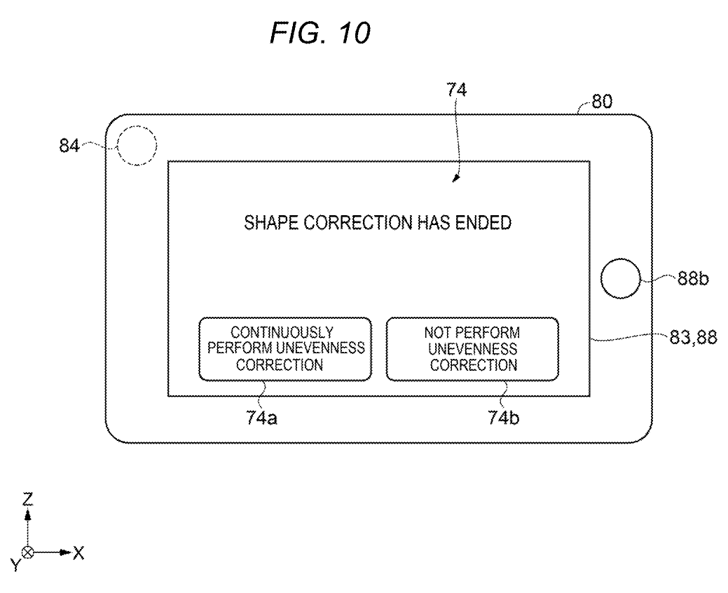

FIG. 10 is a diagram illustrating an example of an operation screen.

When the end operation is performed, an operation screen 74 illustrated in FIG. 10 is displayed on the display 83 of the information processing device 80. Specifically, the controller 81 reads operation screen data from the operation screen data 82d in the storage 82 and displays the operation screen on the display 83. On the operation screen 74, a guide sentence "Shape correction has ended" is displayed and an operation icon 74a for performing unevenness correction and an operation icon 74b for not performing unevenness correction are subsequently displayed.

Here, it is assumed that the operation icon 74a for performing unevenness correction has been operated in step S19. When the operation icon 74b for not performing unevenness correction has been operated, the information processing device 80 ends the adjustment.

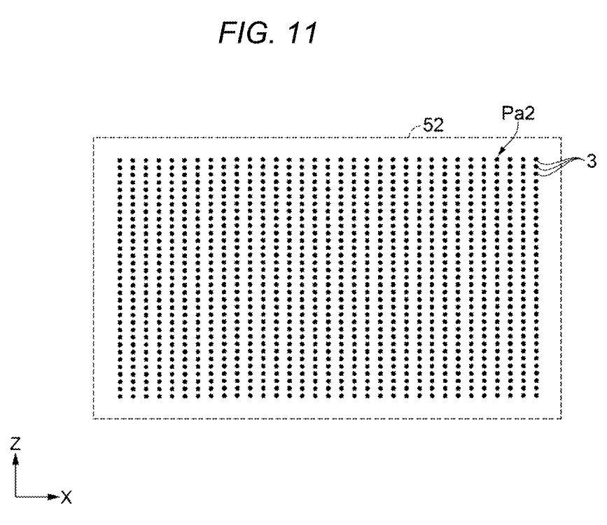

FIG. 11 is a diagram illustrating an example of the fourth image data.

In step S20, the information processing device 80 reads fourth image data from the test image data 82c in the storage 82 and transmits the fourth image data to the projection device 48.

As illustrated in FIG. 11, fourth image data 52 is image data in which a second image pattern Pa2 formed of a dot matrix pattern having a shape similar to a rectangular contour line indicated by a dotted line is arranged in the contour line. The second image pattern Pa2 is a dot matrix pattern in which a plurality of dots 3 are arranged at equal intervals in the X direction and the Z direction. The dot 3 is circular and the center of the dot 3 is a detection point. A percentage of the second image pattern Pa2 in the rectangular contour line is larger than a percentage of the first image pattern Pa1 (FIG. 4). In other words, a margin portion around the second image pattern Pa2 in the fourth image data 52 is narrower than a margin portion in the first image data 51 (FIG. 4). Accordingly, it is possible to apply the unevenness correction also in the peripheral edge portion of the screen SC.

In step S34, the projection device 48 projects an image specified by the received fourth image data 52.

In step S21, the information processing device 80 performs unevenness correction processing. Specifically, kinds of processing of (11) to (14) explained below are performed.

In (11), the information processing device 80 causes the imager 84 to capture a fourth image (not illustrated). At this time, for example, a guide sentence "Please capture and image the entire pattern with the camera from the front of the projection image" is displayed on the display 83.

In (12), the information processing device 80 analyzes the captured image to thereby detect a dot matrix pattern from the captured image. Specifically, the information processing device 80 detects a detection point of the dot matrix pattern. The captured image is equivalent to second captured image data.

In (13), the information processing device 80 determines whether the entire dot matrix pattern has been detected from the captured image in (12) and, when the entire dot matrix pattern has been detected, proceeds to (14) processing. When the entire dot matrix pattern has not been detected, the information processing device 80 returns to the (11) processing.

In (14), the information processing device 80 calculates correction parameters. At this time, the controller 81 functions as an arithmetic unit 81a. The arithmetic unit 81a calculates correction values for each of the dots 3 based on the positions of the dots 3 in the second image pattern Pa2 serving as a reference and the positions of the dots 3 in the captured image and generates correction parameters.

Note that the information processing device 80 may capture a plurality of captured images in (11) and perform an analysis for the captured images and detection determination for the entire dot matrix pattern in (12) and (13).

In step S22, the information processing device 80 transmits the calculated correction parameters to the projection device 48.

In step S35, the projection device 48 generates fifth image data using the correction parameters received by the image processor 46 and projects a fifth image (not illustrated) by the fifth image data. The fifth image is a projection image subjected to unevenness correction in addition to shape correction. The projection device 48 stores parameters including the unevenness correction for the fifth image data in the storage 42.

In other words, the projection device 48 projects the fourth image including the second image pattern Pa2 on the screen SC after projecting the third image. The information processing device 80 acquires the second captured image data obtained by capturing the fourth image and causes, based on data of the fourth image and the second captured image data, the projection device 48 to project the fifth image obtained by performing the unevenness correction on the fourth image.

In step S23, an operation screen (not illustrated) for checking whether to end the unevenness correction is displayed on the display 83 of the information processing device 80. When the continuation icon has been operated, the information processing device 80 returns to step S21 and continues the unevenness correction. When the end icon has been operated, the information processing device 80 ends the unevenness correction.

As explained above, with the display system 110 and the information processing device 80 of the present embodiment, it is possible to obtain the following effects in addition to the effects in the embodiments explained above.

The projection device 48 of the display system 110 projects the fourth image including the second image pattern Pa2 onto the screen SC after projecting the third image. The information processing device 80 acquires the second captured image data obtained by capturing the fourth image and causes, based on the data of the fourth image and the second captured image data, the projection device 48 to project the fifth image obtained by performing the unevenness correction on the fourth image.

Accordingly, it is possible to apply the unevenness correction in addition to the shape correction by the geometric correction and the roll angle correction. Thus, in addition to the shape correction for the projection image, it is possible to correct distortion of the projection image due to slight unevenness of the screen SC, which easily occurs in the short-focus projection device 48. Further, since the unevenness correction is performed on the fourth image subjected to the shape correction, it is possible to optimize an adjustment procedure for the projection image.

Therefore, it is possible to provide the display system 110 that can obtain a projection image having a small roll angle and reduced unevenness distortion.

After causing the projection device 48 to project the third image, the information processing device 80 causes the projection device 48 to project the fourth image including the second image pattern Pa2 onto the screen SC, acquires the second captured image data obtained by capturing the fourth image, and causes, based on the data of the fourth image and the second captured image data, the projection device 48 to project the fifth image obtained by performing the unevenness correction on the fourth image.

Accordingly, it is possible to provide the information processing device 80 suitable for the display system 110 that can obtain a projection image having a small roll angle and reduced unevenness distortion. Further, with the information processing device 80, it is possible to optimize the adjustment procedure for the projection image.

### Modifications

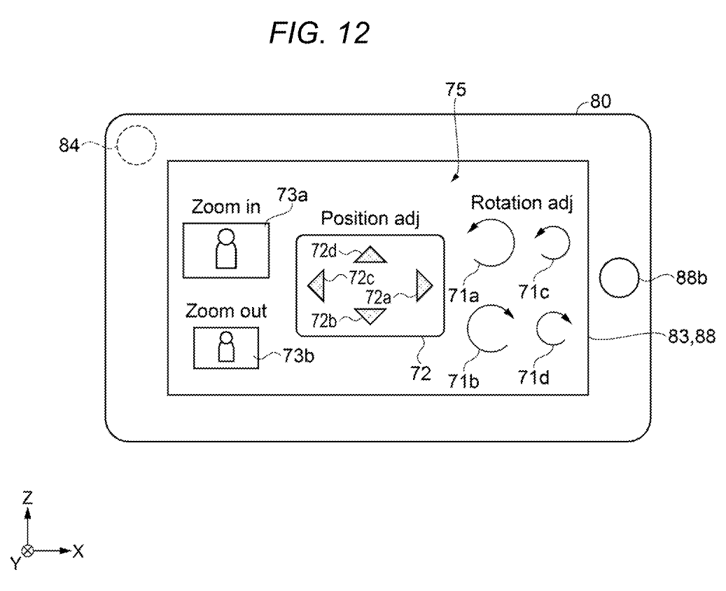

FIG. 12 is a diagram illustrating an example of an adjustment screen according to a modification and corresponds to FIG. 6.

In the above explanation, the two operation icons 71a and 71b for angle adjustment are provided on the adjustment screen 70 (FIG. 6). However, the adjustment screen 75 is not limited thereto and may further include an operation icon for angle adjustment. In the following explanation, the same parts as the parts in the embodiment explained above are denoted by the same reference numerals and signs and a redundant explanation of the parts is omitted.

Four operation icons 71a, 71b, 71c, and 71d for angle adjustment are provided on the adjustment screen 75 in this modification illustrated in FIG. 12. Otherwise, the explanation is the same as the explanation referring to FIG. 6.

In this modification, when the operation icon 71a for angle adjustment is tapped once, the second image 12 (FIG. 5) serving as the second image turns by 5° counterclockwise centering on the center line 60.

The operation icon 71c is provided next to the operation icon 71a and is one size smaller than the operation icon 71a. When the operation icon 71c is tapped once, the projection image turns by 1° counterclockwise centering on the center line 60. Accordingly, after being largely turned by the operation icon 71a, the projection image can be finely adjusted by the operation icon 71c.

Operation by the operation icon 71c is a first angle adjustment operation and operation by the operation icon 71a is a second angle adjustment operation. In other words, the angle adjustment operation includes the first angle adjustment operation by the operation icon 71c and the second angle adjustment operation by the operation icon 71a, a direction in which the second image is rotated about the center line 60, which is the normal vector, by the second angle adjustment operation is the same as a direction in which the second image is rotated about the center line 60 by the first angle adjustment operation and an angle by which the second image is rotated about the center line 60 by the second angle adjustment operation is larger than an angle by which the second image is rotated about the center line 60 by the first angle adjustment operation.

In this modification, when the operation icon 71b for angle adjustment is tapped once, the projection image turns by 5° clockwise centering on the center line 60.

The operation icon 71d is provided next to the operation icon 71b and is one size smaller than the operation icon 71b. When the operation icon 71d is tapped once, the projection image turns by 1° clockwise centering on the center line 60. Accordingly, after being largely turned by the operation icon 71b, the projection image can be finely adjusted by the operation icon 71d.

Further, by operating the operation icons 71a, 71b, 71c, and 71d in combination, the roll angle of the second image 12 can be efficiently adjusted.

Refer back to FIG. 6.

In the above explanation, the second image 12 turns by 3° counterclockwise according to the tap of the operation icon 71a on the adjustment screen 70. However, a rotation angle may be varied by an operation method. Specifically, the second image 12 may turn by 1° according to the tap of the operation icon 71a and turn by 5° according to long press of the operation icon 71a for, for example, two seconds or more. In this case, the operation by the tap of the operation icon 71a is the first angle adjustment operation and the operation by the long press is the second angle adjustment operation. Similarly, the second image 12 may turn by 1° according to the tap of the operation icon 71b and turn by 5° according to the long press of the operation icon 71b for, for example, two seconds or more.

As explained above, according to this modification, effects explained below can be obtained in addition to the effects of the embodiments explained above.

The angle adjustment operation includes the first angle adjustment operation by the operation icon 71c and the second angle adjustment operation by the operation icon 71a, the direction in which the second image is rotated about the center line 60, which is the normal vector, by the second angle adjustment operation is the same as the direction in which the second image is rotated about the center line 60 by the first angle adjustment operation and the angle by which the second image is rotated about the center line 60 by the second angle adjustment operation is larger than the angle by which the second image is rotated about the center line 60 by the first angle adjustment operation.

Accordingly, since the angle adjustment operation includes the first angle adjustment operation and the second angle adjustment operation in which the rotation directions are the same and the rotation angles are different, it is possible for the user to select an adjustment degree such as rough adjustment or fine adjustment for the angle of the second image and it is possible to efficiently perform the angle adjustment operation.

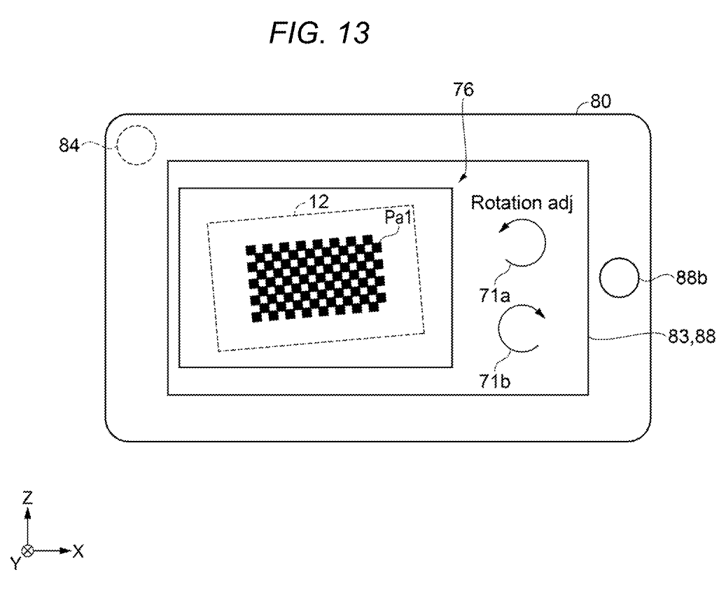

FIG. 13 is a diagram illustrating an example of an adjustment screen according to a modification and corresponds to FIG. 6.

In the above explanation, the operation icons 71a and 71b for angle adjustment, the operation icon 72 for position adjustment, and the operation icons 73a and 73b for enlargement and reduction are provided on the adjustment screen 70 (FIG. 6). However, the adjustment screen 70 is not limited thereto and an imaging screen of a projection screen may be provided on the adjustment screen 70. In the following explanation, the same parts as the parts in the embodiment explained above are denoted by the same reference numerals and signs and a redundant explanation of the parts is omitted.

On the adjustment screen 76 in this modification illustrated in FIG. 13, the two operation icons 71a and 71b for angle adjustment and the imaging screen of the projection screen are displayed. Otherwise, the explanation is the same as the explanation referring to FIG. 6.

On the adjustment screen 76, a captured image obtained by imaging the projection screen with the imager 84 is displayed on the X minus side of the operation icons 71a and 71b. In FIG. 13, the second image 12 serving as a second image before roll angle adjustment is displayed. Accordingly, the user can adjust a roll angle by operating the operation icons 71a and 71b while viewing the imaging screen on the adjustment screen 76. In other words, the information processing device 80 displays the adjustment screen 76 for receiving the angle adjustment operation and the adjustment screen 76 includes the operation icons 71a and 71b serving as angle adjustment operation icons and the captured image captured by the imager 84.

As explained above, according to this modification, effects explained below can be obtained in addition to the effects of the embodiments explained above.

The information processing device 80 displays the adjustment screen 76 for receiving the angle adjustment operation and the adjustment screen 76 includes the operation icons 71a and 71b serving as the angle adjustment operation icons and the captured image captured by the imager 84.

Accordingly, on the adjustment screen 76, by displaying the captured image captured by the imager 84 on the operation screen for receiving the angle adjustment operation, the user can perform the angle adjustment operation while checking the captured image.

Refer back to FIG. 1.

In the above explanation, the screen SC serving as the projection surface is installed on the wall surface of the conference room or the like. However, the projection surface is not limited thereto and the wall surface itself may be used as the projection surface.

Although the second adjustment method is explained as being applied to the short-focus projection device 48, the second adjustment method may be executed by the normal stationary projection device 40. Accordingly, it is possible to obtain a projection image having a small roll angle and reduced unevenness distortion.

### Summary of the present disclosure

A summary of the present disclosure is appended below.

### Appendix 1

A display system including: a projection device configured to project an image; and an information processing device including an imager and an inertial sensor, wherein

the projection device projects a first image including a first image pattern onto a projection surface, and

the information processing device acquires first captured image data obtained by capturing the first image with the imager and thereafter causes the projection device to project a second image obtained by performing geometric correction on the first image based on data of the first image, the first captured image data, and a detection value of the inertial sensor, receives an angle adjustment operation by a user, and causes, based on the angle adjustment operation, the projection device to project a third image obtained by rotating the second image about a normal vector of the projection surface.

According to Appendix 1, it is possible to reduce a roll angle of a corrected projection image with respect to the projection surface by performing the geometric correction on the first image based on first image data serving as a reference, the first captured image data, and the detection value of the inertial sensor and rotating the second image subjected to the geometric correction about the center line 60, which is the normal vector of the projection surface.

Therefore, it is possible to provide a display system that can obtain a projection image having a small roll angle.

### Appendix 2

The display system described in Appendix 1, wherein

the angle adjustment operation includes a first angle adjustment operation and a second angle adjustment operation,

a direction in which the second image is rotated about the normal vector by the second angle adjustment operation is the same as a direction in which the second image is rotated about the normal vector by the first angle adjustment operation, and

an angle by which the second image is rotated about the normal vector by the second angle adjustment operation is larger than an angle by which the second image is rotated about the normal vector by the first angle adjustment operation.

Accordingly, since the angle adjustment operation includes the first angle adjustment operation and the second angle adjustment operation in which the rotation directions are the same and the rotation angles are different, it is possible for the user to select an adjustment degree such as rough adjustment or fine adjustment for the angle of the second image and it is possible to efficiently perform the angle adjustment operation.

### Appendix 3

The display system described in Appendix 1 or 2, wherein

the projection device projects a fourth image including a second image pattern onto the projection surface after projecting the third image, and

the information processing device acquires second captured image data obtained by capturing the fourth image and causes, based on data of the fourth image and the second captured image data, the projection device to project a fifth image obtained by performing unevenness correction on the fourth image.

Accordingly, it is possible to apply the unevenness correction in addition to the shape correction by the geometric correction and the roll angle correction. Thus, in addition to the shape correction for the projection image, it is possible to correct distortion of the projection image due to slight unevenness of the screen SC, which easily occurs in the short-focus projection device 48. Further, since the unevenness correction is performed on the fourth image subjected to the shape correction, it is possible to optimize an adjustment procedure for the projection image.

Therefore, it is possible to provide a display system that can obtain a projection image having a small roll angle and reduced unevenness distortion.

### Appendix 4

The display system described in any one of Appendixes 1 to 3, wherein the information processing device transmits the data of the first image to the projection device.

According to Appendix 4, when the first adjustment program 82a including the first image data is updated, it is unnecessary to update both of a program stored in the projection device 40 and a program stored in the information processing device 80 and only the first adjustment program 82a has to be updated. Thus, it is possible to reduce a work load on the user. The same applies to the second adjustment program 82b.

### Appendix 5

The display system described in any one of Appendixes 1 to 4, wherein

the information processing device displays an adjustment screen for receiving the angle adjustment operation, and

the adjustment screen includes an angle adjustment operation icon and a captured image captured by the imager.

Accordingly, on the adjustment screen 76, by displaying the captured image captured by the imager 84 on the operation screen for receiving the angle adjustment operation, the user can perform the angle adjustment operation while checking the captured image.

### Appendix 6

An information processing device of a display system including: a projection device configured to project an image; and the information processing device including a communicator configured to communicate with the projection device, the information processing device further including an imager and an inertial sensor,

the information processing device acquiring first captured image data obtained by capturing, with the imager, a first image including a first image pattern projected onto a projection surface by the projection device and thereafter causing the projection device to project a second image obtained by performing geometric correction on the first image based on data of the first image, the first captured image data, and a detection value of the inertial sensor, receiving an angle adjustment operation by a user, and causing, based on the angle adjustment operation, the projection device to project a third image obtained by rotating the second image about a normal vector of the projection surface.

According to appendix 6, it is possible to provide an information processing device suitable for a display system that can obtain a projection image having a small roll angle.

### Appendix 7

The information processing device described in Appendix 6, wherein

the angle adjustment operation includes a first angle adjustment operation and a second angle adjustment operation,

a direction in which the second image is rotated about the normal vector by the second angle adjustment operation is the same as a direction in which the second image is rotated about the normal vector by the first angle adjustment operation, and

an angle by which the second image is rotated about the normal vector by the second angle adjustment operation is larger than an angle by which the second image is rotated about the normal vector by the first angle adjustment operation.

According to Appendix 7, it is possible to efficiently perform the angle adjustment operation for the second image.

### Appendix 8

The information processing device described in Appendix 6 or 7, wherein, after causing the projection device to project the third image, the information processing device causes the projection device to project a fourth image including a second image pattern onto the projection surface, acquires second captured image data obtained by capturing the fourth image, and causes, based on data of the fourth image and the second captured image data, the projection device to project a fifth image obtained by performing unevenness correction on the fourth image.

According to Appendix 8, it is possible to provide an information processing device suitable for a display system that can obtain a projection image having a small roll angle and reduced unevenness distortion. With the information processing device, it is possible to optimize an adjustment procedure for the projection image.

### Appendix 9

The information processing device described in any one of Appendixes 6 to 8, wherein the information processing device transmits the data of the first image to the projection device.

According to Appendix 9, when the first adjustment program 82a including the first image data is updated, it is unnecessary to update both of a program stored in the projection device 40 and a program stored in the information processing device 80 and only the first adjustment program 82a has to be updated. Thus, it is possible to reduce a work load on the user. The same applies to the second adjustment program 82b.

### Appendix 10

The information processing device according to any one of Appendixes 6 to 9, wherein

the information processing device displays an adjustment screen for receiving the angle adjustment operation, and

the adjustment screen includes an angle adjustment operation icon and a captured image captured by the imager.

According to Appendix 10, the user can efficiently perform the angle adjustment operation while checking the captured image.

What is claimed is:

1. A display system comprising: a projection device configured to project an image; and an information processing device including an imager and an inertial sensor, wherein
the projection device projects a first image including a first image pattern onto a projection surface, and
the information processing device acquires first captured image data obtained by capturing the first image with the imager and thereafter causes the projection device to project a second image obtained by performing geometric correction on the first image based on data of the first image, the first captured image data, and a detection value of the inertial sensor, receives an angle adjustment operation by a user, and causes, based on the angle adjustment operation, the projection device to project a third image obtained by rotating the second image about a normal vector of the projection surface.

2. The display system according to claim 1, wherein
the angle adjustment operation includes a first angle adjustment operation and a second angle adjustment operation,
a direction in which the second image is rotated about the normal vector by the second angle adjustment operation is the same as a direction in which the second image is rotated about the normal vector by the first angle adjustment operation, and
an angle by which the second image is rotated about the normal vector by the second angle adjustment operation is larger than an angle by which the second image is rotated about the normal vector by the first angle adjustment operation.

3. The display system according to claim 1, wherein
the projection device projects a fourth image including a second image pattern onto the projection surface after projecting the third image, and
the information processing device acquires second captured image data obtained by capturing the fourth image and causes, based on data of the fourth image and the second captured image data, the projection device to project a fifth image obtained by performing unevenness correction on the fourth image.

4. The display system according to claim 1, wherein the information processing device transmits the data of the first image to the projection device.

5. The display system according to claim 1, wherein
the information processing device displays an adjustment screen for receiving the angle adjustment operation, and
the adjustment screen includes an angle adjustment operation icon and a captured image captured by the imager.

6. An information processing device of a display system comprising: a projection device configured to project an image; and the information processing device including a communicator configured to communicate with the projection device,
the information processing device further comprising an imager and an inertial sensor,
the information processing device acquiring first captured image data obtained by capturing, with the imager, a first image including a first image pattern projected onto a projection surface by the projection device and thereafter causing the projection device to project a second image obtained by performing geometric correction on the first image based on data of the first image, the first captured image data, and a detection value of the inertial sensor, receiving an angle adjustment operation by a user, and causing, based on the angle adjustment operation, the projection device to project a third image obtained by rotating the second image about a normal vector of the projection surface.

7. The information processing device according to claim 6, wherein
the angle adjustment operation includes a first angle adjustment operation and a second angle adjustment operation,
a direction in which the second image is rotated about the normal vector by the second angle adjustment operation is the same as a direction in which the second image is rotated about the normal vector by the first angle adjustment operation, and
an angle by which the second image is rotated about the normal vector by the second angle adjustment operation is larger than an angle by which the second image is rotated about the normal vector by the first angle adjustment operation.

8. The information processing device according to claim 6, wherein
after causing the projection device to project the third image, the information processing device causes the projection device to project a fourth image including a second image pattern onto the projection surface, acquires second captured image data obtained by capturing the fourth image, and causes, based on data of the fourth image and the second captured image data, the projection device to project a fifth image obtained by performing unevenness correction on the fourth image.

9. The information processing device according to claim 6, wherein the information processing device transmits the data of the first image to the projection device.

10. The information processing device according to claim 6, wherein
the information processing device displays an adjustment screen for receiving the angle adjustment operation, and
the adjustment screen includes an angle adjustment operation icon and a captured image captured by the imager.
